(19) United States
(12) Patent Application Publication
(10) Pub. No.: US 2010/0299425 A1
(43) Pub. Date: Nov. 25, 2010

(54) LICENSE TRANSFER SYSTEM, LICENSE TRANSFER METHOD, AND LICENSE TRANSFER PROGRAM

(75) Inventor: Tetsuya Yamada, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/770,400

(22) Filed: Apr. 29, 2010

(30) Foreign Application Priority Data
May 19, 2009 (JP) 2009-121147

(51) Int. Cl. G06F 15/173

(52) U.S. Cl. 709/223

(57) ABSTRACT

The first image forming apparatus is the image forming apparatus for the license transfer source. The second image forming apparatus is the transfer destination image forming apparatus to which a license is transferred. The license management apparatus centrally manages the issue status and the like of a license for an application to be installed on each image forming apparatus. The registration of the license to the license management apparatus is performed by the application seller through the sales company system and the like. The device management apparatus has the function of collecting, accumulating, processing the information of the image forming apparatus to be managed and the information indicating the operating state thereof, and externally providing a warning and the like. The distribution/transfer management apparatus manages the license/application to be distributed/transferred, and the state of distribution/transfer processing for the license/application.

### BACKGROUND OF THE INVENTION

1. Field of the Invention

The present invention relates to a license transfer system for controlling the execution of an application installed in an information processing apparatus.

2. Description of the Related Art

For business reasons, preventing an application installed in an information processing apparatus from being executed by other information processing apparatus is necessary. Hence, a system or method of managing execution rights (licenses) in the information processing apparatus by a license issuance server has been realized. For example, for transferring the once-given license due to several reasons, such as a failure of the information processing apparatus, new purchase, and the like, first, processing to invalidate a license is carried out by the information processing apparatus of the transfer source. Subsequently, a transferred invalidated license file verifying that invalidation processing has been performed is issued, and the issued file is subjected to a predetermined process by a license issuance server. Finally, a transfer license which is available for the transfer destination device is issued (see for example, Japanese Patent Laid-Open No. 2006-107468).

### SUMMARY OF THE INVENTION

However, in the prior arts including the technique disclosed in Japanese Patent Laid-Open No. 2006-107468, a user needs to perform each operation for transferring a license on an as-needed basis. In general, many applications are required for dealing with business instead of one application. For this reason, the transferring of a license is carried out very frequently, and thereby a user must perform the operation involving a license transfer on an as-needed basis.

In order to overcome the circumstances associated with the prior art described above, the present invention provides a license transfer system for enabling efficient license transfer processing without the need of user intervention.

According to an aspect of the present invention, a license transfer system is provided which performs processing for transferring a license, including a first image forming apparatus that includes a license managing unit configured to invalidate a transferring license and a transferred invalidated license issuing unit configured to issue an invalidated license clarifying that the transferring license has been invalidated, a second image forming apparatus that includes an installation unit configured to install a transfer license, a license management apparatus that includes an information management database that holds and manages the license and the information for an apparatus to which the license is assigned and a license issuing unit configured to issue the transfer license installable on the second image forming apparatus based on the invalidated license, and a transfer management apparatus that includes a transfer processing managing unit configured to manage the state of transfer processing through which the transfer license that has been issued by the license management apparatus is transferred to the second image forming apparatus.

According to the present invention, a license transfer system for enabling efficient license transfer processing without the need of user intervention may be provided. Further features of the present invention will become apparent from the following description of exemplary embodiments with reference to the attached drawings.

### BRIEF DESCRIPTION OF THE DRAWINGS

FIG. 1 is a diagram illustrating a schematic configuration of a license transfer system according to an embodiment of the present invention.

FIG. 2 is a block diagram illustrating a general configuration of a first image forming apparatus 102 and a second image forming apparatus 103.

FIG. 3 is a block diagram illustrating a hardware configuration of a controller 201.

FIG. 4 is a block diagram illustrating the main functional configuration of the controller 201.

FIG. 5 is a diagram illustrating an example of boot program management data to be managed by a boot program identification unit 402.

FIG. 6 is a diagram illustrating an example of management information to be managed by a license management section 403.

FIG. 7 is a block diagram illustrating a hardware configuration of a license management apparatus 104.

FIG. 8 is a block diagram illustrating the functional configuration of the license management apparatus 104.

FIG. 9 is a diagram illustrating an example of information to be stored in an information management database 601.

FIG. 10 is a block diagram illustrating the functional configuration of a device management apparatus 105.

FIG. 11 is a block diagram illustrating the functional configuration of a distribution/transfer management apparatus 106.

FIG. 12 is a diagram illustrating an example of information to be stored in a database 801.

FIG. 13 is a flowchart illustrating the procedure of license transfer processing.

FIG. 14 is a state transition diagram illustrating transfer processing states to be managed by the distribution/transfer management apparatus 106.

FIG. 15 is a flowchart illustrating the processing procedure of the distribution/transfer management apparatus 106 upon the occurrence of a transfer processing instruction (step S1301).

FIG. 16 is a flowchart illustrating the processing procedure of the distribution/transfer management apparatus 106 upon the occurrence of a transfer processing request (step S1302).

FIG. 17 is a flowchart illustrating the processing procedure of the distribution/transfer management apparatus 106 upon the occurrence of a transfer processing request (step S1303).

FIG. 18 is a flowchart illustrating the processing procedure of the distribution/transfer management apparatus 106 upon the occurrence of a transfer preparation completed notification (step S1305).

FIG. 19 is a flowchart illustrating the processing procedure of the distribution/transfer management apparatus 106 upon the occurrence of a transfer preparation completed notification (step S1306).

FIG. 20 is a flowchart illustrating the processing procedure of the distribution/transfer management apparatus 106 upon the occurrence of a license request (step S1307).

### DESCRIPTION OF THE EMBODIMENTS

Hereinafter, preferred embodiments of the present invention will now be described with reference to the attached drawings.

### <License Transfer System>

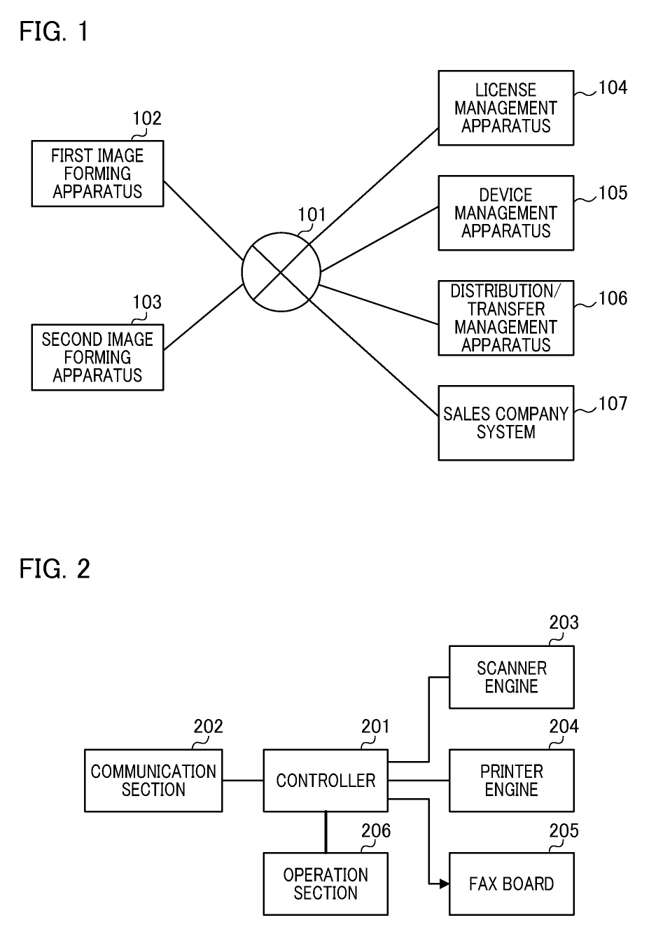

FIG. 1 is a diagram illustrating a schematic configuration of a license transfer system according to an embodiment of the present invention. The license transfer system 100 includes a first image forming apparatus 102, a second image forming apparatus 103, a license management apparatus 104, a device management apparatus 105, a distribution/transfer management apparatus 106, and a sales company system 107. The aforementioned functional sections are mutually connected via a network 101. The network 101 includes not only a LAN and a WAN, but also includes access to the Internet.

The first image forming apparatus 102 is an image forming apparatus from which a license is to be transferred. The second image forming apparatus 103 is a destination image forming apparatus to which a license is transferred. Note that a PC may also be employed instead of these image forming apparatuses. The license management apparatus 104 centrally manages the issue status and the like of a license for an application to be installed on the image forming apparatus. The registration of the license to the license management apparatus 104 is performed by the application seller through the sales company system 107 and the like. The license acquisition is performed through the distribution/transfer management apparatus 106 and the sales company system 107. The device management apparatus 105 has the functions of collecting, accumulating, processing the information of the image forming apparatus to be managed and the information indicating the operating state thereof (including fault information), and externally providing a warning and the like. Further, the device management apparatus 105 receives an input from the outside and submits a notification of information to the image forming apparatus. The distribution/transfer management apparatus 106 manages the license/application to be distributed/transferred, and the state of distribution/transfer processing for the license/application. The application to be distributed is uploaded through the sales company system 107, and the license is acquired through a request made to the license management apparatus 104. In order to provide a notification indicating the start of distribution/transfer processing to the image forming apparatus, this notification is provided to the device management apparatus 105.

The license management apparatus 104, the device management apparatus 105; and the distribution/transfer management apparatus 106 are under control of a business enterprise that develops and sells application (e.g., the sales company system 107). In some cases, the business enterprise that develops and sells application may be different from the business enterprise that makes sales to a customer (sales company). Accordingly, the sales company accesses the license management apparatus 104, the device management apparatus 105, and the distribution/transfer management apparatus 106 using the sales company system 107 as the front end to input and output information and the like.

### <Image Forming Apparatus>

FIG. 2 is a block diagram illustrating a general configuration of the first image forming apparatus 102 and the second image forming apparatus 103. The first image forming apparatus 102 (the second image forming apparatus 103) includes a controller 201, a communication section 202, a scanner engine 203, a printer engine 204, a FAX board 205, and an operation section 206.

The controller 201 controls the overall image forming apparatus (detailed later). The communication section 202 controls communication with the external equipment of the image forming apparatus through the controller 201. The communication section 202 may be, for example, an Ethernet (registered trademark), an IEE1284, or other communication function. Also, the communication section 202 is not limited to any one of these. The scanner engine 203 is controlled by the controller 201. The printer engine 204 is controlled by the controller 201. The printer engine 204 may be the one which is compatible with, for example, a laser printer, an inkjet printer, or other printer. The FAX board 205 is for realizing a FAX function such as communication control while transmitting/receiving an image, and is controlled by the controller 201. The operation section 206 is constituted by a display such as an LCD (Liquid Crystal Display), a keyboard, and the like. The operation section 206 has a function to display information provided from the controller 201 and convey user instructions to the controller 201.

With the image forming apparatus configured in this manner, a scan job can be issued by selecting the scanner engine 203. Copy job can be issued by selecting the printer engine 204 and the scanner engine 203. Furthermore, FAX reception job and FAX transmission job can be issued by selecting the printer engine 204, the scanner engine 203, and the FAX board 205.

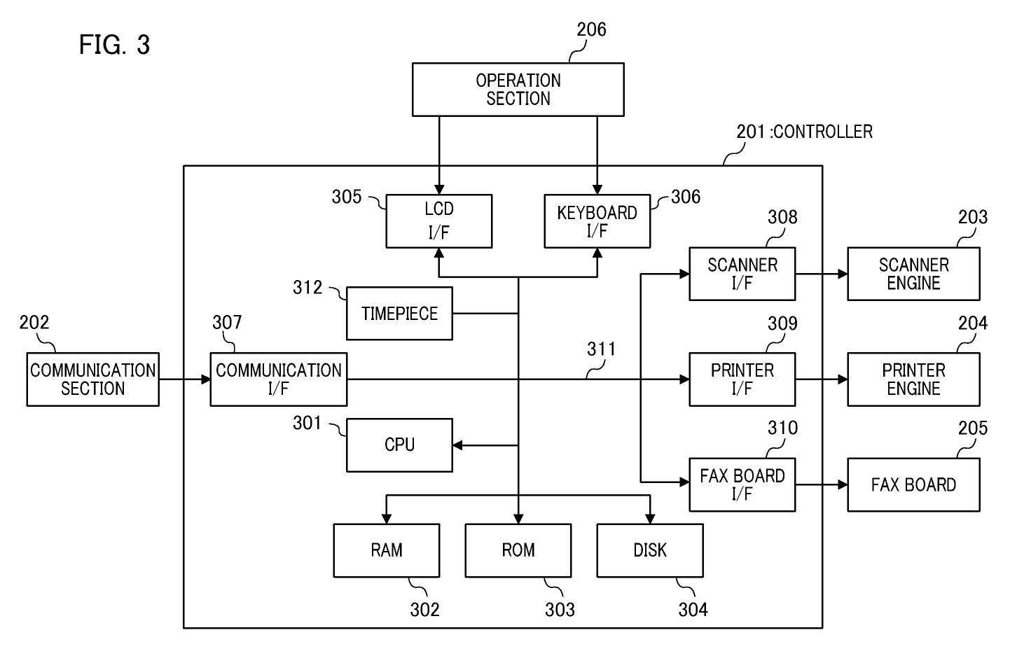

Next, a description will be given of a hardware configuration of the controller 201 shown in FIG. 2. FIG. 3 is a block diagram illustrating a hardware configuration of the controller 201. The controller 201 includes a CPU (Central Processing Unit) 301, a RAM (Random Access Memory) 302, a ROM (Read Only Memory) 303, a DISK 304, and an LCD interface (hereinafter referred to as “I/F”) 305. The controller 201 further includes a keyboard I/F 306, a communication I/F 307, a scanner I/F 308, a printer I/F 309, a FAX I/F 310, and a timepiece 312. These functional sections are mutually connected via a system bus 311.

A program for controlling a controller 201 is stored in the ROM 303 or the DISK 304. A required module is read out to the RAM 302 by a program management section 501 to be described below, and executed by the CPU 301. The ROM 303 and the DISK 304 store attribute information indicating the function and state of a job to be processed by the image forming apparatus, job data to be output, and the like in addition to the control program. The CPU 301 executes the display of information, messages, and the like through the operation section 306 and the LCD I/F 305, and user instructions are received from the keyboard I/F 306. In addition, the CPU 301 executes communication with an external equipment through the communication I/F 307.

Note that in the present embodiment, unless otherwise specified, in the image forming apparatus shown in the FIG. 2, the CPU 301 receives an input from a user via the keyboard I/F 306 through the system bus 311. Then, the CPU 301 controls the RAM 302, the ROM 303, the DISK 304, the LCD I/F 305, the communication I/F 307, the scanner engine I/F 308, the printer engine I/F 309, and the FAX board I/F 310.

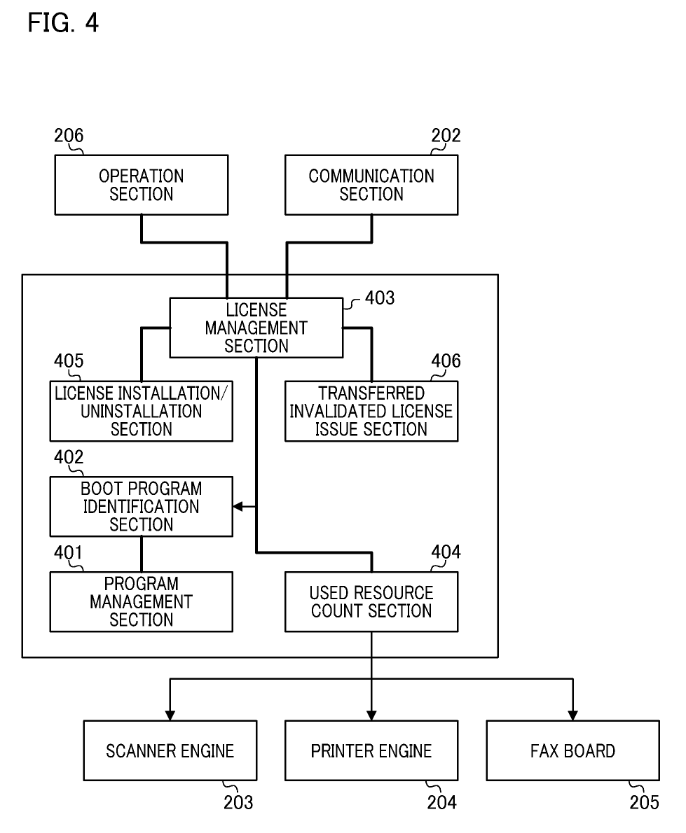

Next, a description will be given of a functional configuration of the controller 201 shown in FIG. 2. FIG. 4 is a block diagram illustrating the main functional configuration of the controller 201. The controller 201 includes a program management section 401, a boot program identification section 402, a license management section 403, an use resource count section 404, a license installation/uninstallation section 405, and a transferred invalidated license issue section 406.

The program management section 401 operates immediately after the activation of the controller 201. The program management section 401 sequentially activates the program/module to be activated in accordance with information held by the boot program identification section 402 to be described below. The boot program identification section 402 manages information of the program/module to be activated. The license management section 403 performs a predetermined process in accordance with the command that has been transmitted via the operation section 206 or the communication section 202. The use resource count section 404 counts the resources to be used in the scanner engine 203, the printer engine 204, and the FAX board 205 for each program/module. The license installation/uninstallation section 405 performs a license installation/uninstallation process in accordance with the instructions given by the license management section 403. Specifically, the installation/uninstallation section 405 performs installation processing of the transferred license or uninstallation processing of the license currently being held. The transferred invalidated license issue section 406 issues a “transferred invalidated license” clarifying that uninstallation has been carried out according to the instructions from the license management section 403, when the license has been uninstalled prior to the transmission to other device. Note that these functional sections can realize their functions by causing the CPU 301 shown in FIG. 3 to execute the control program described above.

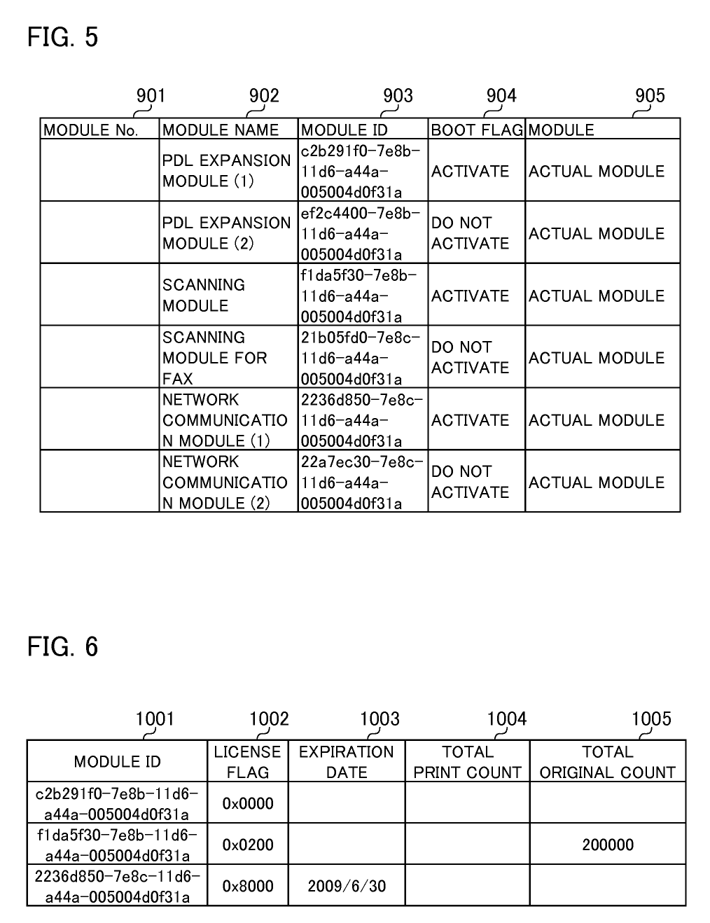

Next, a description will be given of boot program management data to be managed by the boot program identification section 402. FIG. 5 is a diagram illustrating an example of boot program management data to be managed by the boot program identification unit 402. The boot program management data 900 is configured such that a record holds information for one program/module. In

FIG. 5, a number field 901 is a field in which a module number sequentially appended to a program/module to be managed as boot program management data is stored. A module name field 902 is a field in which the name of a program/module is stored. A module ID field 903 is a field in which the module ID for uniquely identifying a program/module is stored. In the present embodiment, an UUID (Universal Unique ID) is employed. A boot flag/field 904 is a field in which the information for identifying the presence or absence of the activation of the program/module is stored. A module field 905 is a field in which the reference status to the entity of the program/module is stored. In other words, the program management section 401 executes the program/module of the reference destination shown in the module field 905 in accordance with the contents of the boot flag/field.

While in the present embodiment, a table is employed as a method for managing a program/module to be activated, the management method is not particularly limited to such an example as long as it can identify the presence or absence of the relevant program/module and its activation. Also, the information for uniquely identifying the program/module is not limited to the UUID.

Next, a description will be given of management information to be managed by the license management section 403. FIG. 6 is a diagram illustrating an example of management information to be managed by the license management section 403. In FIG. 6, the module ID field 1001 is a field where the information for specifying the program/module being managed is stored, and the content of the module ID 903 is stored therein. The license flag field 1002 is a field where the identification information for identifying license information given to the module ID 1001 is stored, and in which any one of the licenses (described below) to be used by each bit of data is shown. For example, the license item where the bit is not ON indicates that a license is not present. In the present embodiment, the most significant bit (0×8000) is stored in an expiration date field 1003 to be described below, and the total print count field 1004 shows the state that the subsequent bit (0×4000) is stored. Note that in the present embodiment, a method for holding identification information is not particularly limited. The expiration date field 1003 is a field in which the license information indicating the expiration date is stored. While in the present embodiment, the absolute date time (date) is used, an effective period such as the dates for which it is in effect may also be used. The total print count field 1004 is a field in which the license information of the available total impression counts is stored. The total original count field 1005 is a field in which the license information of the available total original counts is stored. Note that in the present embodiment, the content of the available resource is not particularly limited, but may be, for example, the number of byte of data transmitted on the network.

### <License Management Apparatus>

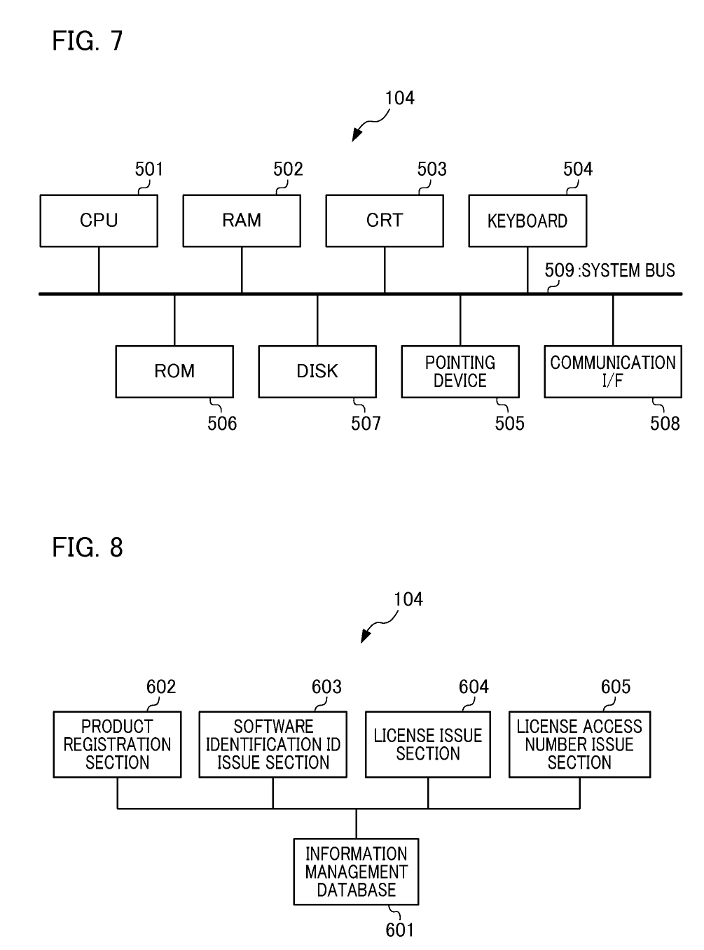

Next, a description will be given of a hardware configuration of the license management apparatus 104 shown in FIG. 1. FIG. 7 is a block diagram illustrating a hardware configuration of the license management apparatus 104. The license management apparatus 104 may also be configured on a general use computer. As shown in FIG. 7, the license management apparatus 104 includes a CPU 501, a RAM 502, a CRT (Cathode Ray Tube) 503, a keyboard 504, a pointing device 505, a ROM 506, a DISK 507, and a communication I/F 508. These functional sections are connected to each other via a system bus 509.

A program for controlling the license management apparatus 104 is stored in the ROM 506 or the DISK 507. The program is read out to the RAM 502 as required, and executed by the CPU 501. The CPU 501 performs display processing through the CRT 503, and receives user instructions from the keyboard 504 and the pointing device 505. In addition, the CPU 501 executes communication with external equipment through the communication I/F 508. Note that in the present embodiment, unless otherwise specified, in the license management apparatus 104, the CPU 501 receives an input from a user via the keyboard 504 and the pointing device 505 through the system bus 509. Then, the CPU 501 controls the RAM 502, the CRT 503, the ROM 506, the DISK 507, and the communication I/F 508.

Next, a description will be given of a functional configuration of the license management apparatus 104. FIG. 8 is a block diagram illustrating the functional configuration of the license management apparatus 104. The license management apparatus 104 includes an information management database 601, a product registration section 602, a software identification ID issue section 603, a license issue section 604, and a license access number issue section 605.

The information management database 601 stores information to be managed by the functional sections constituting the license management apparatus 104. The product registration section 602 registers product information (product name, product code, license period, and the like) of the application to be sold. Even for the same application, a different version is referred to as a “product”. A product is identified by the product code. The software identification ID issue section 603 specifies the number of licenses with respect to the application that has been registered by the product registration section 602 to thereby issue a software identification ID (SID). The SID is appended to the package of the application, and is employed as information for identifying the application upon license issuance. The license issue section 604 inputs the identification information (device serial number (DS#)) of the device to be installed each time an application is purchased, and then issues a license. In addition, when the transmission of the license is performed between devices, the license issue section 604 receives a transferred invalidated license for clarifying that the license has been invalidated by the transfer source device, rewrites the license management information, and then issues a transfer license key which is a license for the transfer destination device. The license access number issue section 605 issues an identification number (LA#) required for acquiring a license online. Upon issuance, the same information as that required by the license issue section 604 is input. Note that these functional sections can realize their functions by causing the CPU 501 shown in FIG. 7 to execute a predetermined control program.

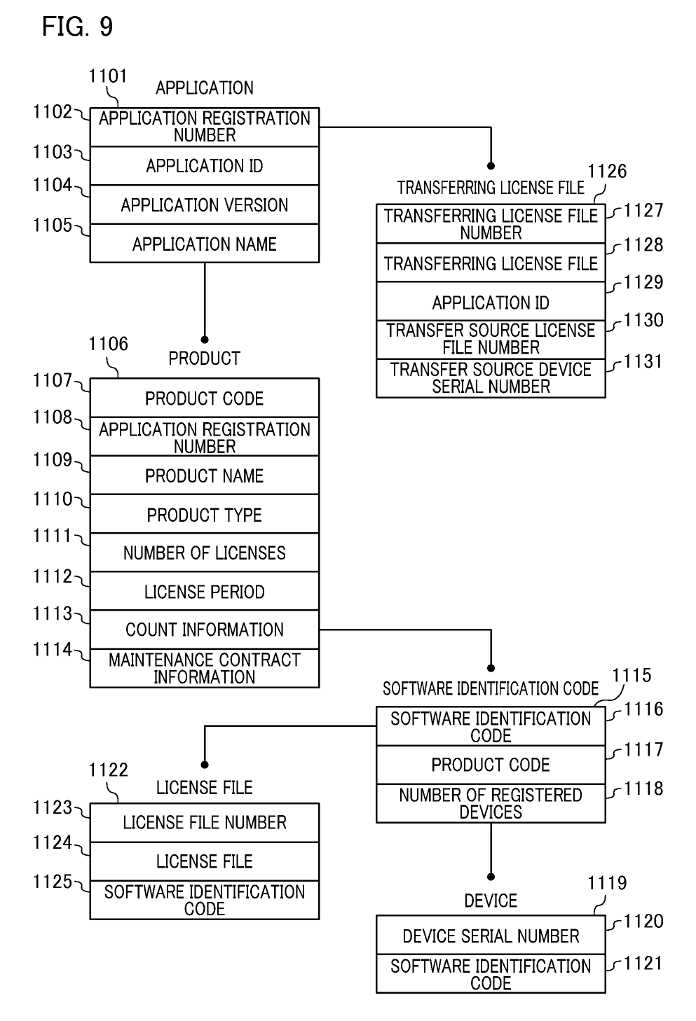

Next, a description will be given of information to be stored in the information management database 601. FIG. 9 is a diagram illustrating an example of information to be stored in an information management database 601. The information management database 601 stores application information, product information including license information, software identification code information, and device serial number information. The term “software” means the same as general use software that creates value by installing it on an information processing apparatus for operation. The term “application” means software developed by a software developer in order to enable performing particular processing on an information processing apparatus. The term “product” is an unit of sale defined by a sales entity/distribution channel/license condition of an application that has been registered in the present system, and will be used by a user by installing it on the user's own information processing apparatus after the product is purchased by the user.

An application table 1101 stores the following items in order to uniquely identify an application on the present system. Specifically, the items are an application registration number 1102, an application ID 1103, an application version 1104, and an application name 1105. A product table 1106 stores a product code 1107, an application registration number 1108, a product name 1109, a product type 1110, a number of licenses 1111, a license period 1112, count information 1113, and maintenance contract information 1114. A plurality of products may exist for the same application, since an application and a product are in a one-to-many relationship. A software identification code table 1115 stores a software identification code 1116, a product code 1117, and a number of registered devices 1118. A plurality of software identification codes may exist for the same product, since a product and a software identification code are in a one-to-many relationship. A device table 1119 stores a device serial number 1120, and a software identification code 1121. A plurality of devices may exist for the same software identification code, since the software identification code 1121 and a device are in a one-to-many relationship. A license file table 1112 stores a license file number 1123, a license file 1124, and a software identification code 1125. A software identification number and a license file are in a one-to-one relationship. A plurality of license file numbers may exist for the same license file, since the license file 1124 and the license file number 1123 are in a one-to-many relationship. A transferring license file table 1126 stores a transferring license file number 1127, a transferring license file 1128, an application ID 1129, a transfer source license file number 1130, and a transfer destination device serial number 1131. A plurality of transfer license file numbers may exist for the same application ID, since the application ID 1129 and the transferring license file number 1127 are in a one-to-many relationship.

### <Device Management Apparatus>

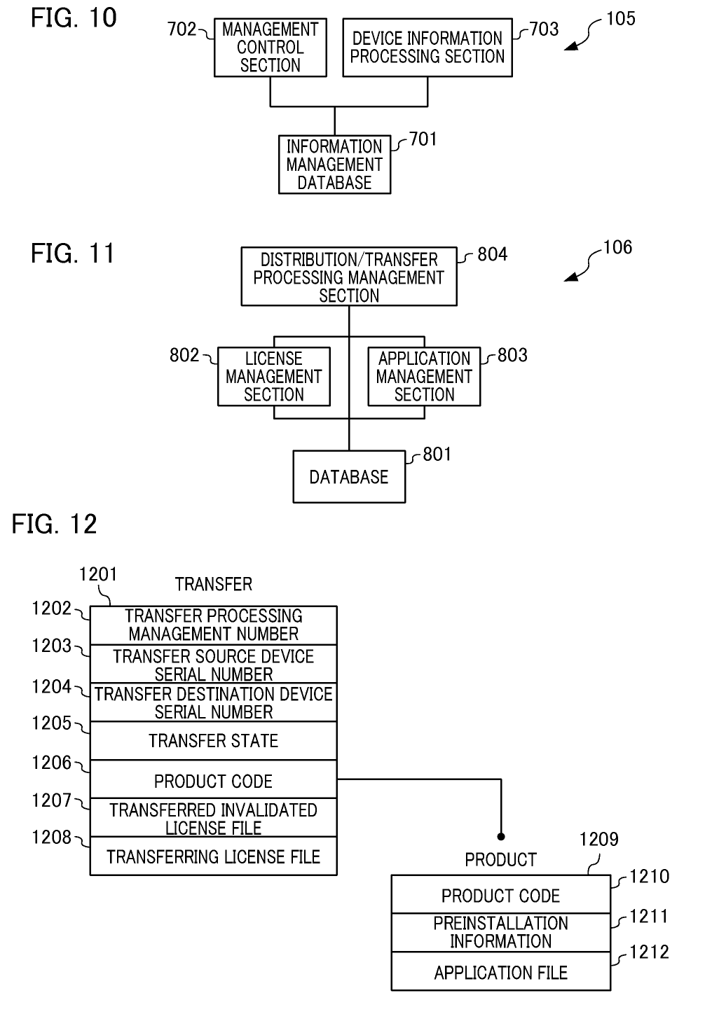

Next, a description will be given of a functional configuration of the device management apparatus 105 shown in FIG. 1. Note that the hardware configuration of the device management apparatus 105 is the same as that shown in FIG. 7, and explanation thereof will be omitted. FIG. 10 is a block diagram illustrating the functional configuration of the device management apparatus 105. The device management apparatus 105 includes an information management database 701, a management control section 702, and a device information processing section 703.

The information management database 701 stores information about each device, an operational status, information to be reported, settings for a management method, and the like. The information management database 701 is accessed from the management control section 702 and the device information processing section 703 so as to perform input and output of information. The management control section 702 updates information to be reported to each image forming apparatus that is stored in the information management database 701, acquires information of each image forming apparatus, and manages a management schedule thereof in accordance with an instruction from the distribution/transfer management apparatus (transfer management apparatus) 106 and the like. The device information processing section 703 accumulates information such as counter information, service calls, jams, being out of toner, or the like into the information management database 701 depending on the schedule to be managed by the management control section 702. Such information is actively collected from the first image forming apparatus 102 and the second image forming apparatus 103 by the device management apparatus 105.

### <Distribution/Transfer Management Apparatus>

Next, a description will be given of a functional configuration of the distribution/transfer management apparatus 106 shown in FIG. 1. Note that the hardware configuration of the distribution/transfer management apparatus 106 is the same as that shown in FIG. 7, and explanation thereof will be omitted. FIG. 11 is a block diagram illustrating the functional configuration of the distribution/transfer management apparatus 106. The distribution/transfer management apparatus 106 includes a database 801, a license management section 802, an application management section 803, and a distribution/transfer processing management section 804.

The database 801 stores the actual license/application to be distributed/transferred and the information associated therewith. The license management section 802 performs operations for licenses in accordance with the instructions given by the distribution/transfer processing management section 804 so as to make a request for license acquisition/transfer processing to the license management apparatus 104 and to perform input/output operations to the database 801. The application management section 803 performs input/output operations to the database 801 as required in accordance with the instructions given by the distribution/transfer processing management section 804. The distribution/transfer processing management section 804 manages the state of distribution/transfer, and determines, depending on the state, the processing upon reception of the request from the first image forming apparatus 102 and the second image forming apparatus 103 and the information/data from the device management apparatus 105 for execution.

Next, a description will be given of the form of information to be stored in the database 801. FIG. 12 is a diagram illustrating an example of information to be stored in the database 801. The database 801 stores information relating to each individual transfer processing and information of the application to be distributed/transferred.

In FIG. 12, an information table 1201 stores information relating to each individual transfer processing. For example, the information table 1201 stores a transfer processing management number 1202, a transfer source device serial number 1203, a transfer destination device serial number 1204, a transfer state 1205 indicating in which phase of transfer processing is in processing, and a product code 1206 relating to a product tied with a license to be transferred. The information table 1201 further stores a transferred invalidated license file 1207 and a transferring license file 1208. The transfer processing management number 1202 is automatically allocated by the present system for the management of each processing. The transfer source device serial number 1203 is input when a transferred invalidated license has been transmitted from a transfer source device. The transfer destination device serial number 1204 is input by a sales company personnel via the input apparatus (e.g., keyboard) of the distribution/transfer management apparatus, or is transmitted from the transfer source device. The transfer state 1205 is managed by the distribution/transfer management apparatus. The product code 1206 is acquired from the license management apparatus 104 as information tied with a license. The transferred invalidated license file 1207 is sent from a transfer source image processing apparatus. The transferring license file 1208 is sent after transfer processing is performed by the license management apparatus 104. A distribution/transfer application table 1209 is a table of an application to be distributed/transferred. For example, a product code 1210 and preinstallation information 1211 indicating whether or not a product is to be preinstalled in the image forming apparatus are stored therein. Furthermore, an application file 1212, which stores a product not to be preinstalled, is also stored therein.

### <License Transfer Processing and Management of Transfer Processing State>

Hereinafter, a schematic description will be given of the processing to be performed upon license transfer by the devices constituting the license transfer system 100 and information/data being passed upon license transfer. A transfer processing state to be managed by the distribution/transfer management apparatus 106 in order to realize automatic license transfer processing including error processing will also be described.

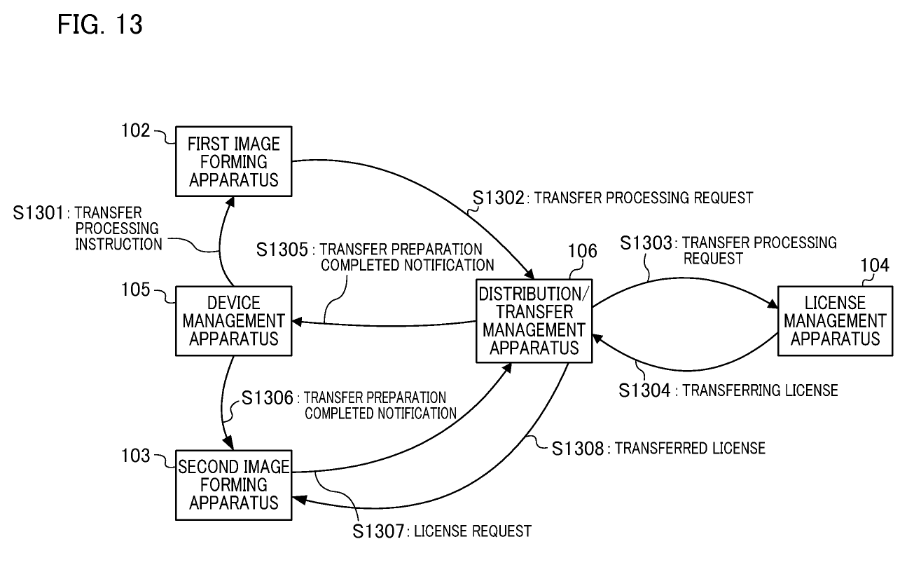

First, a description will be given of the license transfer processing performed by the license transfer system of the present embodiment. FIG. 13 is a flowchart illustrating the procedure for license transfer processing.

In the flowchart shown in FIG. 13, first, the device management apparatus 105 transmits a transfer processing instruction to the first image forming apparatus 102 (transfer source) (step S1301). Here, it is assumed that the first image forming apparatus 102 receives a transfer processing instruction from the device management apparatus 105. In this case, sales company personnel or the like inputs a transfer instruction to the device management apparatus 105, and the device management apparatus 105 provides instructions to perform transfer processing via the network 101. The device management apparatus 105 transmits an indication that the distribution/transfer management apparatus 106 has been instructed to carry out transfer processing.

Next, the first image forming apparatus 102 transmits a transfer processing request to the distribution/transfer management apparatus 106 (step S1302). At this time, a transferring invalidated certification license and a device serial number of the image forming apparatus of the transfer source are transmitted. When the image forming apparatus of the transfer destination is specified upon transfer instruction, the device serial number thereof is also transmitted. When transfer processing is unsuccessful, an error notification is transmitted to the device management apparatus, and the device management apparatus transfers the error notification to the distribution/transfer management apparatus. Note that the transfer processing instruction in step S1301 may be derived from the operation section 206 of the image forming apparatus. However, in this case, a notification is not sent to the distribution/transfer management apparatus 106.

The distribution/transfer management apparatus 106 is an example of a distribution management apparatus. When the distribution/transfer management apparatus 106 receives a transfer processing request from the first image forming apparatus 102, the distribution/transfer management apparatus 106 checks data, and, if there is any defect, provides an error notification to the first image forming apparatus 102 (transfer source). If there is no defect, the distribution/transfer management apparatus 106 transmits a transfer processing request to the license management apparatus 104 (step S1303).

When the license management apparatus 104 receives a transfer processing request from the distribution/transfer management apparatus 106, the license management apparatus 104 performs transfer processing. If transfer processing is successfully completed, the license management apparatus 104 issues a transferring license to the distribution/transfer management apparatus 106 (step S1304). If unsuccessful, the license management apparatus 104 transmits an error notification to the distribution/transfer management apparatus 106. In the following description, the term “transferring license” refers to a license to be transferred from the first image forming apparatus, whereas the term “transfer license” refers to a license to be transferred from the second image forming apparatus.

When the distribution/transfer management apparatus 106 receives a transfer license from the license management apparatus 104, the distribution/transfer management apparatus 106 stores the transfer license in the database 801 as well as transmits a transfer preparation completed notification to the device management apparatus 105 (step S1305).

When the device management apparatus 105 receives the transfer preparation completed notification from the distribution/transfer management apparatus 106, the device management apparatus 105 transmits the transfer preparation completed notification to the second image forming apparatus 103 (transfer destination) (step S1306). Then, the device management apparatus 105 transmits the transmission results (success or failure) to the distribution/transfer management apparatus 106.

When the second image forming apparatus 103 receives a transfer preparation completed notification from the device management apparatus 105, the second image forming apparatus 103 makes a request for a transferring license to the distribution/transfer management apparatus 106 (step S1307). When the distribution/transfer management apparatus 106 receives a license request from the second image forming apparatus 103, the distribution/transfer management apparatus 106 searches the database 801 to transmit a transfer license back to the second image forming apparatus 103 (step S1308).

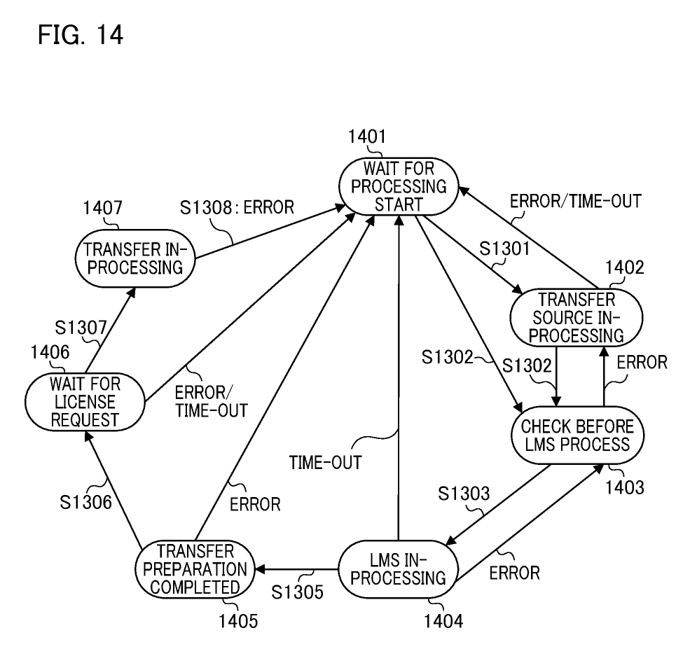

Next, each state when license transfer processing shown in FIG. 13 is executed is shown. FIG. 14 is a state transition diagram illustrating transfer processing states to be managed by the distribution/transfer management apparatus 106. A “wait for processing start” state 1401 shows the state where transfer processing is not performed. An “transfer source in-processing” state 1402 shows the state in which any kind of processing is being performed in the transfer source (the first image forming apparatus 102). A “check before LMS process” state 1403 shows the state in which a transfer processing request content is checked by the distribution/transfer management apparatus 106 before transfer processing is performed by the license management apparatus 104. An “LMS in-processing” state 1404 shows the state in which transfer processing is being performed by the license management apparatus 104. A “transfer preparation completed” state 1405 shows the state in which the transferring license issued by the license management apparatus 104 is held on the distribution/transfer management apparatus 106. A “wait for license request” state 1406 shows the state in which the distribution/transfer management apparatus 106 waits for a license transfer request from the transfer destination (the second image forming apparatus 103). An “transfer in-processing” state 1407 shows the state in which transfer processing is being performed. by the distribution/transfer management apparatus 106.

<Details of Management of Transfer Processing State and Process upon the occurrence of each event>

Hereinafter, a detailed description will be given of how the distribution/transfer management apparatus 106 manages the transfer processing state upon the occurrence of each event to thereby perform required processing.

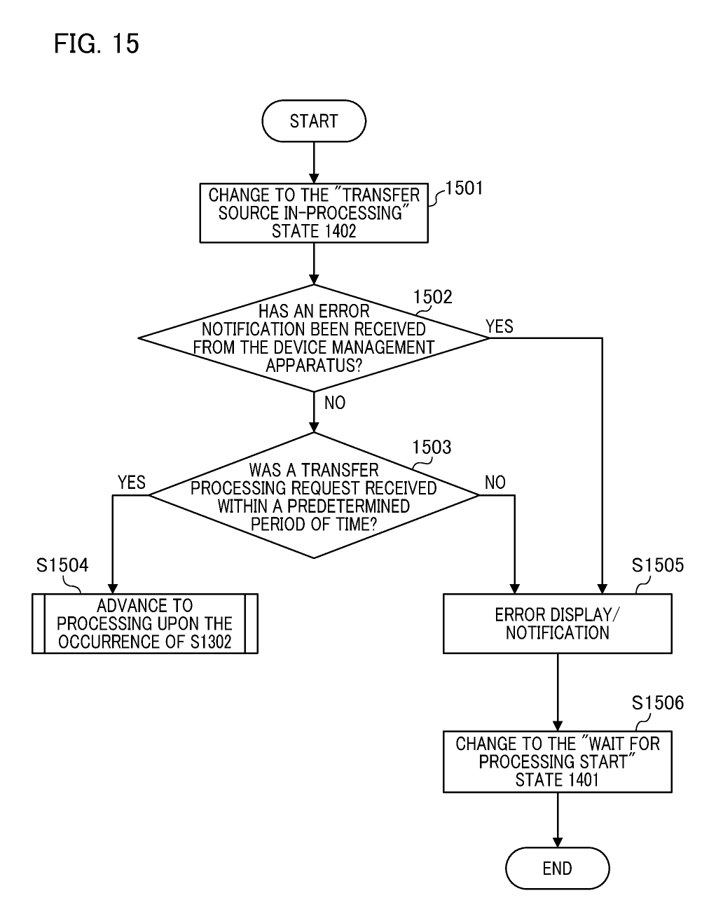

First, processing performed by the distribution/transfer management apparatus 106 upon the occurrence of a transfer processing instruction shown in FIG. 13 (step S1301) will be described. FIG. 15 is a flowchart illustrating the processing procedure of the distribution/transfer management apparatus 106 upon the occurrence of a transfer processing instruction (step S1301).

In the flowchart shown in FIG. 15, first, the distribution/transfer processing management section 804 changes the transfer processing state to the “transfer source in-processing” state (step S1501). Specifically, the distribution/transfer processing management section 804 changes the transfer processing state from the “wait for processing start” state 1401 shown in FIG. 14 to the “transfer source in-processing” state 1402. Next, the distribution/transfer processing management section 804 detects from the device management apparatus 105 whether or not an error notification indicating that transfer processing performed by the first image forming apparatus 102 (transfer source) was unsuccessful has been received (step S1502).

If the error notification has not been received in step S1502 (No in step S1502), the distribution/transfer processing management section 804 detects whether or not a transfer processing request has been received from the first image forming apparatus 102 within a predetermined period of time (step S1503). Here, if a transfer processing request has been received from the first image forming apparatus 102 within a predetermined period of time (Yes in step S1503), the transfer processing request shown in FIG. 13 (step S1302) is executed (step S1504). On the other hand, if a transfer processing request has not been received from the first image forming apparatus 102 within a predetermined period of time (No in step S1503), the distribution/transfer processing management section 804 provides an error display/notification (step S1505). As error display/notification processing carried out at this stage, displaying to the display section (CRT) of the distribution/transfer management apparatus 106 and providing an E-mail notification to a previously specified person can be considered. Thereafter, the distribution/transfer processing management section 804 changes the transfer processing state to the “wait for processing start” state 1401 (step S1506), and the process is terminated.

Also, if the error notification has been received in step S1502 (Yes in step S1502), the subsequent processing from step S1505 is executed.

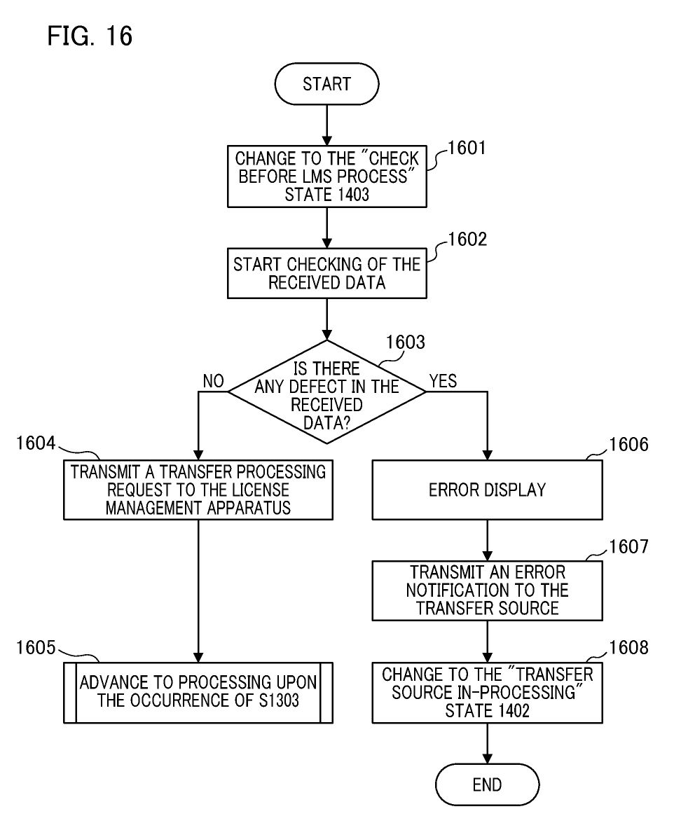

Next, processing performed by the distribution/transfer management apparatus 106 upon the occurrence of the transfer processing request shown in FIG. 13 (step S1302) will be described. FIG. 16 is a flowchart illustrating the processing procedure of the distribution/transfer management apparatus 106 upon the occurrence of a transfer processing request (step S1302).

In the flowchart shown in FIG. 16, first, the distribution/transfer processing management section 804 changes the transfer processing state to the “check before LMS process” state 1403 (step S1601). Next, the distribution/transfer processing management section 804 starts checking the received data (step S1602). Here, for example, the device serial number or the like of the received data is checked. Subsequently, the distribution/transfer processing management section 804 determines whether or not there is any defect in the received data (step S1603). Here, if there is no defect in the received data (No in step S1603), the distribution/transfer processing management section 804 transmits a transfer processing request to the license management apparatus 104 (step S1604). Then, the transfer processing request shown in FIG. 13 (step S1303) is executed (step S1605). On the other hand, if there is any defect in the received data in step S1603 (Yes in step S1603), the distribution/transfer processing management section 804 gives an error display (step S1606). As error display processing carried out at this stage, display on the display section (CRT) of the distribution/transfer management apparatus 106 is contemplated. Subsequently, the distribution/transfer processing management section 804 transmits an error notification (a notification indicating that there is a defect in the received data) to the transfer source (the first image forming apparatus 102) (step S1607). Then, the distribution/transfer processing management section 804 changes the transfer processing state to the “transfer source in-processing” state 1402 (step S1608).

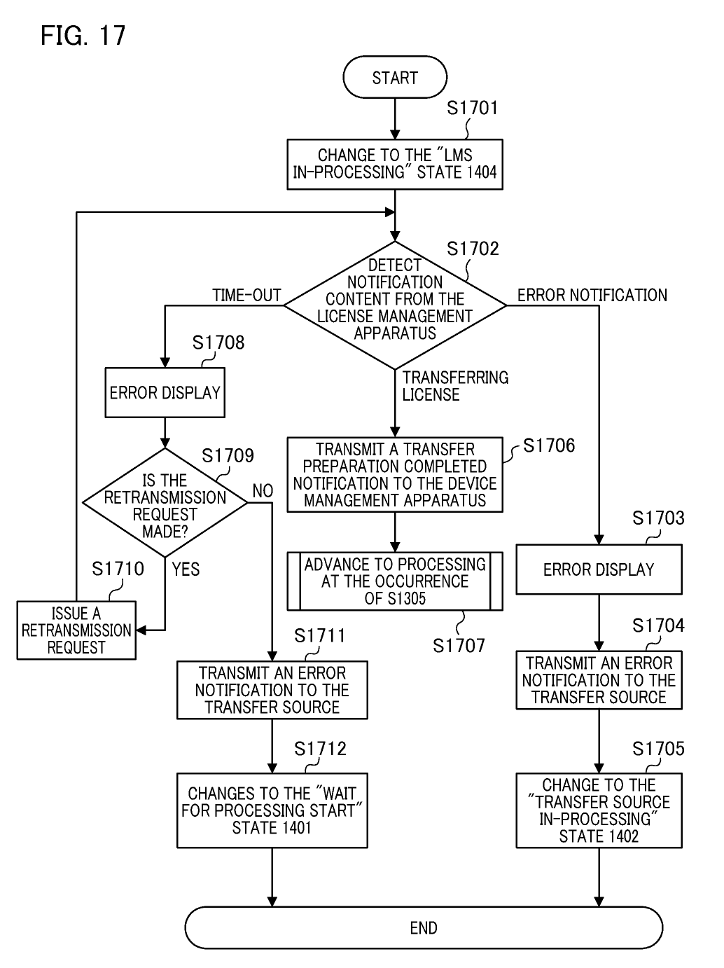

Next, processing performed by the distribution/transfer management apparatus 106 upon the occurrence of the transfer processing request shown in FIG. 13 (step S1303) will be described. FIG. 17 is a flowchart illustrating the processing procedure of the distribution/transfer management apparatus 106 upon the occurrence of a transfer processing request (step S1303).

In the flowchart shown in FIG. 17, first, the distribution/transfer processing management section 804 changes the transfer processing state to the “LMS in-processing” state 1404 (step S1701). Next, the distribution/transfer processing management section 804 detects the notification content from the license management apparatus 104 (step S1702).

If an error notification indicating that transfer processing has been unsuccessful in step S1702 is received from the license management apparatus 104, the distribution/transfer processing management section 804 gives an error display (step S1703). As error display processing carried out at this stage, display on the display section (CRT) of the distribution/transfer management apparatus 106 is contemplated. Subsequently, the distribution/transfer processing management section 804 transmits an error notification to the transfer source (the first image forming apparatus 102), and provides for the modification of the transfer processing request content (step S1704). Then, the distribution/transfer processing management section 804 changes the transfer processing state to the “transfer source in-processing” state 1402 (step S1705).

If a transferring license has been received from the license management apparatus 104 in step S1702, the distribution/transfer processing management section 804 stores the transferring license in the database 801. Subsequently, a transfer preparation completed notification is transmitted to the device management apparatus 105 (step S1706) so as to execute processing upon the occurrence of the transfer preparation completed notification shown in FIG. 13 (step S1305) (step S1707).

If a time-out has occurred in step S1702 (i.e., if more than a predetermined time period has elapsed after the transfer processing state has changed to the “LMS in-processing” state 1401), the distribution/transfer processing management section 804 gives an error display (step S1706). As an error display carried out at this stage, display on the display section (CRT) of the distribution/transfer management apparatus 106 is contemplated. The cause of an error may be the fact that the license management apparatus 104 is not operating temporarily. Hence, the distribution/transfer processing management section 804 provides a predetermined display to the display section (CRT) of the distribution/transfer management apparatus 106, which allows a user to select whether or not a retransmission request (another transfer processing request) is made to the license management apparatus 104 (step S1709). Here, if the retransmission request has been selected (Yes in step S1709), the distribution/transfer processing management section 804 makes a retransmission request to the license management apparatus 104 (step S1710). Then, the processing from step S1702 is executed again. On the other hand, if the retransmission request has not been selected (No in step S1709), the distribution/transfer processing management section 804 transmits an error notification to the transfer source (the first image forming apparatus 102) (step S1711). Then, the distribution/transfer processing management section 804 changes the transfer processing state to the “wait for processing start” state 1401 (step S1712).

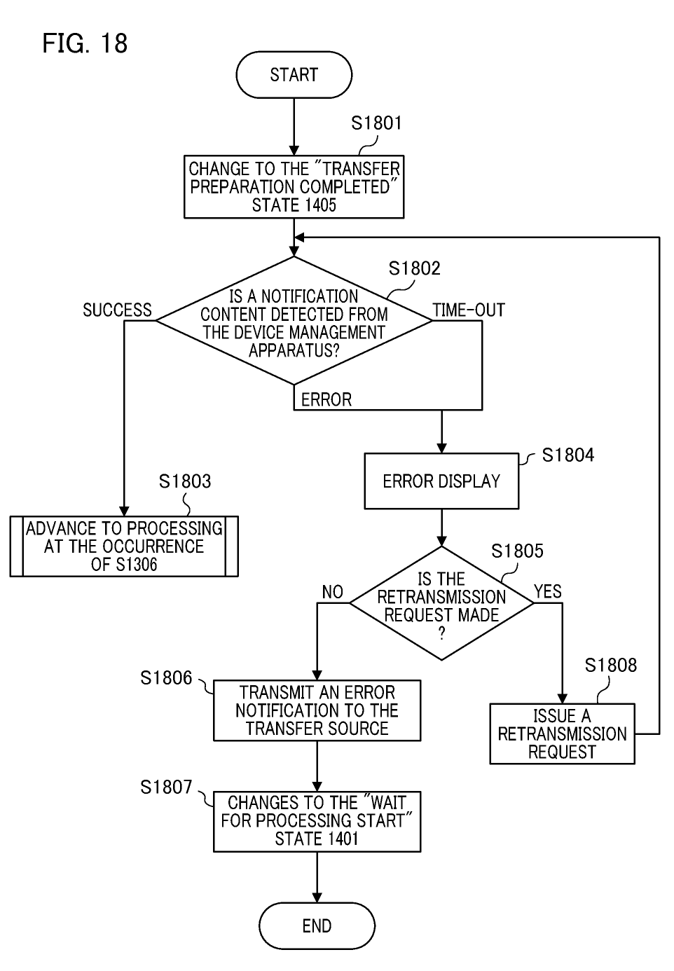

Next, processing performed by the distribution/transfer management apparatus 106 upon the occurrence of the transfer preparation completed notification shown in FIG. 13 (step S1305) will be described. FIG. 18 is a flowchart illustrating the processing procedure of the distribution/transfer management apparatus 106 upon the occurrence of a transfer preparation completed notification (step S1305).

In the flowchart shown in FIG. 18, first, the distribution/transfer processing management section 804 changes the transfer processing state to the “transfer preparation completed” state 1405 (step S1801). Next, the distribution/transfer processing management section 804 detects a notification content from the device management apparatus 105 (step S1802).

If a notification that indicates the transfer preparation completed notification has been successfully transmitted to the second image forming apparatus 103 (transfer destination) has been received from the device management apparatus 105 in step S1802, processing upon the occurrence of the transfer preparation completed notification in step S1306 in FIG. 13 is executed (step S1803).

If a notification that indicates the transfer preparation completed notification has been unsuccessfully transmitted to the second image forming apparatus 103 (transfer destination) has been received from the device management apparatus 105 in step S1802, the distribution/transfer processing management section 804 gives an error display (step S1804). As an error display carried out at this stage, display to the display section (CRT) of the distribution/transfer management apparatus 106 is contemplated. Next, the distribution/transfer processing management section 804 provides a predetermined display on the display section (CRT) of the distribution/transfer management apparatus 106, which allows a user to select whether or not a request for the retransmission of the transfer preparation completed notification is to be made to the device management apparatus 105 (step S1805). Here, if the retransmission request has been selected (Yes in step S1805), the distribution/transfer processing management section 804 makes a retransmission request to the device management apparatus 105 (step S1808). Then, the processing from step S1802 is executed again. On the other hand, if the retransmission request has not been selected (No in step S1805), the distribution/transfer processing management section 804 transmits an error notification to the transfer source (the first image forming apparatus 102) (step S1806). Then, the distribution/transfer processing management section 804 changes the transfer processing state to the “wait for processing start” state 1401 (step S1807).

Also, if a time-out has occurred in step S1802 (i.e., if more than a predetermined time period has elapsed after the transfer processing state has changed to the “transfer preparation completed” state 1405), the subsequent processing from step S1804 is executed.

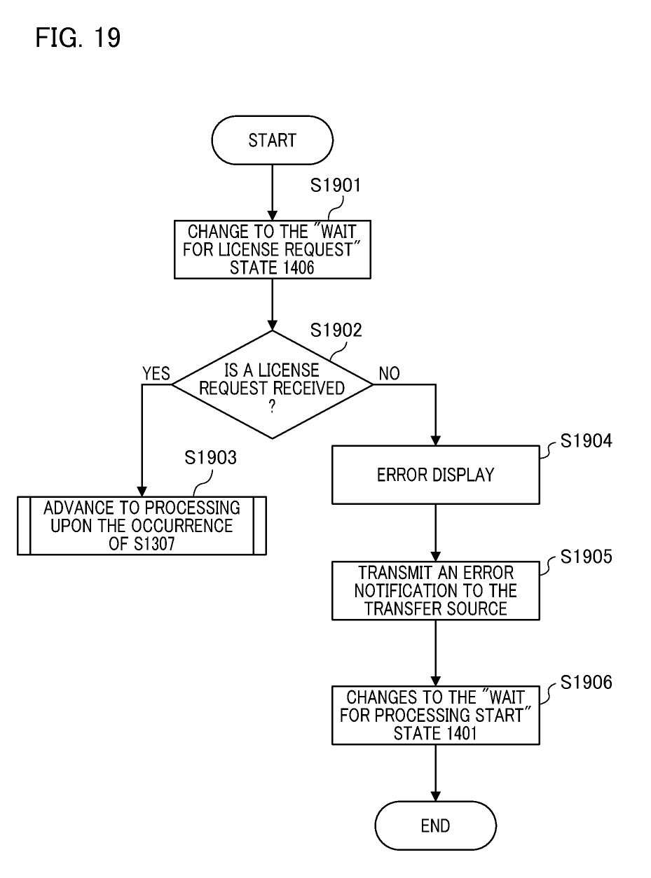

Next, the processing performed by the distribution/transfer management apparatus 106 upon the occurrence of the transfer preparation completed notification shown in FIG. 13 (step S1306) will be described. FIG. 19 is a flowchart illustrating the processing procedure of the distribution/transfer management apparatus 106 upon the occurrence of a transfer preparation completed notification (step S1306).

In the flowchart shown in FIG. 19, first, the distribution/transfer processing management section 804 changes the transfer processing state to the “wait for license request” state 1406 (step S1901). Next, the distribution/transfer processing management section 804 detects whether or not a license request has been received from the second image forming apparatus 103 (transfer destination) (step S1902). Here, if the license request has been received (Yes in step S1902), processing upon the occurrence of the license request (step S1307) shown in FIG. 13 is executed (step S1903). On the other hand, if the license request has not been received (No in step S1902), the distribution/transfer processing management section 804 gives an error display (step S1904). As used herein, the expression “if the license request has not been received” refers to a case where the license request has not been made within a predetermined period of time after the transfer processing state has changed to the “wait for license request” state 1406. As error display processing carried out at this stage, a display on the display section (CRT) of the distribution/transfer management apparatus 106 is contemplated. Subsequently, the distribution/transfer processing management section 804 performs an error notification (a notification indicating that the license request has not been made) to the transfer source (the first image forming apparatus 102) (step S1906). Then, the distribution/transfer processing management section 804 changes the transfer processing state to the “wait for processing start” state 1401 (step S1906).

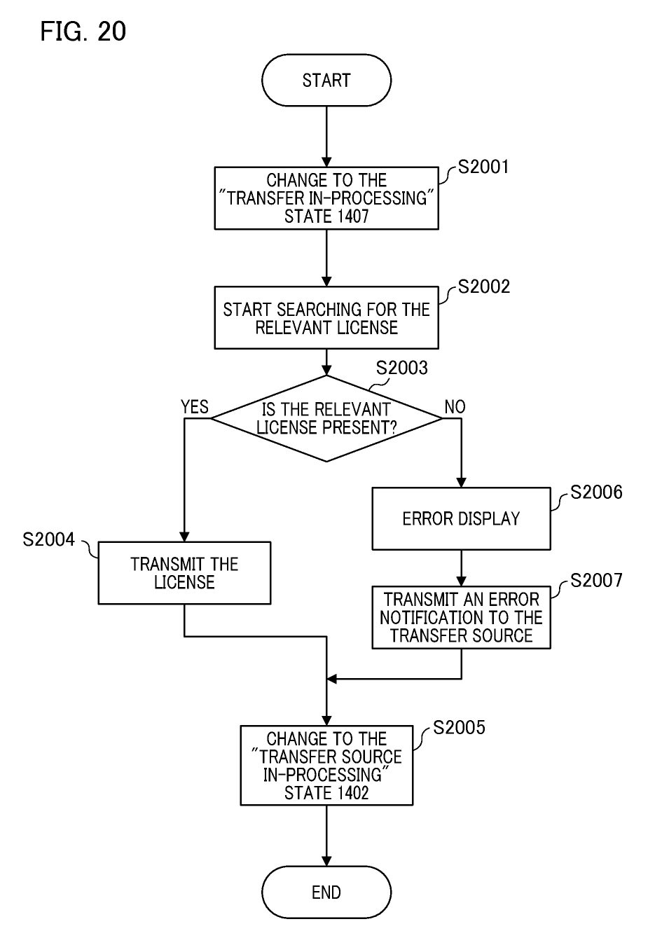

Next, processing performed by the distribution/transfer management apparatus 106 upon the occurrence of the license request (step S1307) shown in FIG. 13 will be described. FIG. 20 is a flowchart illustrating the processing procedure of the distribution/transfer management apparatus 106 upon the occurrence of a license request (step S1307).

In the flowchart shown in FIG. 20, first, the distribution/transfer processing management section 804 changes the transfer processing state to the “transfer in-processing” state 1407 (step S2001). Next, the license management section 802 starts searching for the license relevant to the database 801 (step S2002). Subsequently, the license management section 802 determines whether or not the relevant license is present (step S2003). Here, if the relevant license is present (Yes in step S2003), the distribution/transfer processing management section 804 transmits the license to the transfer destination (the second image forming apparatus 103). Then, the distribution/transfer processing management section 804 changes the transfer processing state to the “transfer source in-processing” state 1402 (step S2005).

On the other hand, if the relevant license is absent in step S2003 (No in step S2003), the distribution/transfer processing management section 804 gives an error display (step S2006). The specific processing is the same as step S1904 shown in FIG. 19. Subsequently, the distribution/transfer processing management section 804 transmits an error notification (a notification indicating that the relevant license is absent) to the transfer source (the first image forming apparatus 102) (step S2007). Then, the distribution/transfer processing management section 804 changes the transfer processing state to the “transfer source in-processing” state 1402 (step S2005).

As described above, according to the present embodiments, a license transfer system for enabling efficient license transfer processing without the need of user intervention may be provided. In other words, even if processing across the apparatuses constituting the license transfer system occurs, processing depending on the transfer processing state can be quickly executed, whereby license transfer processing including error processing can be realized efficiently.

### Other Embodiments

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the embodiments of the present invention have been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-121147 filed May 19, 2009 which is hereby incorporated by reference herein in its entirety.

What is claimed is:

1. A license transfer system that performs processing for transferring a license, comprising:
a first image forming apparatus comprising:
a license managing unit configured to invalidate a transferring license; and
a transferred invalidated license issuing unit configured to issue an invalidated license clarifying that the transferring license has been invalidated;
a second image forming apparatus comprising:
an installation unit configured to install a transfer license;
a license management apparatus comprising:
an information management database that holds and manages the license and the information of an apparatus to which the license is assigned; and
a license issuing unit configured to issue the transfer license installable to the second image forming apparatus based on the invalidated license; and
a transfer management apparatus comprising:
a transfer processing managing unit configured to manage the state of transfer processing through which the transfer license that has been issued by the license management apparatus is transferred to the second image forming apparatus.

2. The license transfer system according to claim 1, further comprising:
a device management apparatus that provides a notification/instruction to the first image forming apparatus and the second image forming apparatus,
wherein the device management apparatus provides an instruction about the transfer of the transferring license to the first image forming apparatus, the first image forming apparatus that has received the instruction makes a request of transfer processing of the transferring license to the transfer management apparatus, and the transfer management apparatus that has received the request receives the transferring license from the license management apparatus so as to provide a transfer preparation-completion notification of the transfer license to the device management apparatus.

3. The license transfer system according to claim 1, wherein the device management apparatus that has received a transfer preparation-completion notification of the transfer license transmits the transfer preparation-completion notification to the second image forming apparatus, the second image forming apparatus that has received the completion notification makes a request of a transfer license to the transfer management apparatus, and the transfer management apparatus transfers the transfer license to the second image forming apparatus in response to the request.

4. The license transfer system according to claim 1, wherein any one of the transfer management apparatus, the first image forming apparatus, the second image forming apparatus, and the license management apparatus further comprises a determination unit configured to determine whether or not transfer processing of the license is being processed.

5. The license transfer system according to claim 1, wherein the transfer management apparatus further comprises a detection unit configured to detect an error of license transfer processing.

6. A license transfer method that performs processing for transferring a license, comprising the steps of:
invalidating a transferring license in a first image forming apparatus;
issuing an invalidated license clarifying that the transferring license has been invalidated in the first image forming apparatus;
issuing a transfer license installable from a license management apparatus to a second image forming apparatus based on the invalidated license;
transferring the issued transfer license from a distribution management apparatus to the second image forming apparatus; and
installing the transfer license on the second image forming apparatus.

7. The license transfer method according to claim 6, further comprising the steps of:
providing an instruction about the transfer of the transferring license from a device management apparatus to the first image forming apparatus;
making a request of transfer processing of the transferring license from the first image forming apparatus that has received the instruction to the transfer management apparatus; and
providing a transfer preparation-completion notification of the transfer license to the device management apparatus after the transfer management apparatus that has received the request receives the transferring license from the license management apparatus.

8. The license transfer method according to claim 6, further comprising the steps of:
transmitting a transfer preparation-completion notification from the device management apparatus that has received the transfer preparation-completion notification of the transfer license to the second image forming apparatus;
making a request of a transfer license from the second image forming apparatus that has received the completion notification to the transfer management apparatus; and
transferring the transfer license from the transfer management apparatus to the second image forming apparatus in response to the request.

9. The license transfer method according to claim 6, wherein any one of the transfer management apparatus, the first image forming apparatus, the second image forming apparatus, and the license management apparatus further comprises a step of determining whether or not transfer processing of the license is being processed.

10. The license transfer method according to claim 6, wherein the transfer management apparatus further comprises a step of detecting an error of the license transfer processing.
